(19) United States
(12) Patent Application Publication
(10) Pub. No.: US 2009/0264051 A1
(43) Pub. Date: Oct. 22, 2009

(54) Self-sharpening tool blade and method

(76) Inventor: Peter W. Lesche, Millville, NJ (US)

Correspondence Address: Hollstein Keating Cattell;Johnson & Goldstein, P.C., Willow Ridge Executive Office Partk, 750 Route 73 South, Suite 301, Marlton, NJ, 08053, US

(21) Appl. No.: 12/148,608

(22) Filed: Apr. 21, 2008

(51) Int. Cl. B24B 1/00; B26B 9/02

(52) U.S. Cl. 451/45; 30/357

(57) ABSTRACT

A self-sharpening tool blade is to be used on shovels, spades, cultivating tools, garden hand tools, and other tools and mechanical equipment which need to have consistently sharp cutting edges in order to penetrate into and dig in the ground. The blade utilizes the concept of differential surface wear for self-sharpening. The back side of the tool blade sustains more wear than the top side, since it is most often in contact with more abrasive soil and earth debris, while the blade's top side is usually in contact with abrasive materials which exert less abrasion and less pressure than that which the back side experiences. This is due to the manner in which digging occurs; that is the top side of the blade contacts soil and soil debris which is free to move away from the blade during digging, whereas soil material contacting the back side of the blade is, for the most part, compacted and immovable, providing a higher degree of abrasive friction. The difference in abrasive forces and pressure differential between the top side and back side of the blades serves to maintain and, over time, sharpens the taper angle of the blade.

### BACKGROUND OF THE INVENTION

The invention relates to the field of metal blades used to penetrate the earth for digging, moving soil and root cutting; especially those blades used for heavy manual and/or mechanical work performed by gardeners, landscapers, nurserymen, hardscapers, contractors, road builders, farmers and like workers. It has been found that under normal usage of these types of bladed tools, the front or leading edge of the blade becomes dull due to the method of sharpening applied at the time of original manufacture. These blades are normally sharpened on what would be considered the top side of the blade, as exemplified in U.S. Pat. No. 4,396,214.

In use, the normal abrasion of the cutting edge of these types of blades occurs primarily on the back sides of the blades, causing the leading edges of the blades to wear down. This results from the fact that, during the digging operation, the soil, dirt, debris, etc. on the back side of the blade is normally hard and compacted, presenting a higher abrasion factor and higher pressure as compared to the soil material contacting the blade's top side which has been loosened and is free to move. This causes the top side cutting edge of the blade to wear more quickly and become dull and, of course, tools with dull blades are ineffective. Time and money must be spent to sharpen these blades, if that is even a reasonable option, or the tool must be discarded.

Prior attempts to “self-sharpen” blades have included the use of coatings on core blade surfaces or applying a plurality of layers to form laminated cutting structures to provide a measure of blade wear protection. Other blade systems position separate, abrasive sharpening components to act on the blade while it is being used. However, none of these prior attempts have been successful in providing a simple, highly effective and simply designed self-sharpening blade product.

### SUMMARY OF THE INVENTION

It is thus the object of the present invention to overcome the disadvantages and limitations of prior sharp edged tool blades.

It is an object of the present invention to provide a tool blade which uses the forces that normally dull the forward cutting edge of the blade to make it self-sharpening.

It is another object of the present invention to provide a tool blade which takes advantage of the differential wear rates of metal to soil interaction to keep the blade sharp.

It is still another object of the present invention to provide a tool blade with an appropriate taper on the back side of a blade to facilitate the use of differential wear rates to maintain and increase the taper angle of the blade over the life of the blade, thus keeping it sharp.

It is a further object of the present invention to provide a tool blade which eliminates the frustration and expense associated with constant hand or mechanical re-sharpening needed to maintain the original tapered edge and keep it sharp.

It is another object of the present invention to provide a tool blade which eliminates the need to replace a bladed tool once its blade has become dull.

It is a further object of the present invention to provide a tool blade which can be constructed of a suitable heat treated metal designed to be self-sharpened during use.

These and other objectives are accomplished by the present invention, a self-sharpening tool blade to be used on shovels, spades, cultivating tools, garden hand tools, and other tools and mechanical equipment which need to have consistently sharp cutting edges in order to penetrate into and dig in the ground. The blade utilizes the concept of differential surface wear for self-sharpening. The back side of the tool blade sustains more wear than the top side, since it is most often in contact with more abrasive soil and earth debris, while the blade's top side is usually in contact with abrasive materials which exert less abrasion and less pressure than that which the back side experiences. This is due to the manner in which digging occurs; that is the top side of the blade contacts soil and soil debris which is free to move away from the blade during digging, whereas soil material contacting the back side of the blade is, for the most part, compacted and immovable, providing a higher degree of abrasive friction. The difference in abrasive forces and pressure differential between the top side and back side of the blades serves to maintain and, over time, sharpens the taper angle of the blade.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of the tool blade of the present invention.

FIG. 2 is an elevation view of the tool blade of the present invention.

FIG. 3 is an end, partial elevation view of the tool blade of the present invention.

FIG. 4 is a cross-sectional view of the tool blade of the present invention in use.

FIG. 5 is a close-up view of the end of the tool blade of the present invention, showing forces applied on the blade during its use.

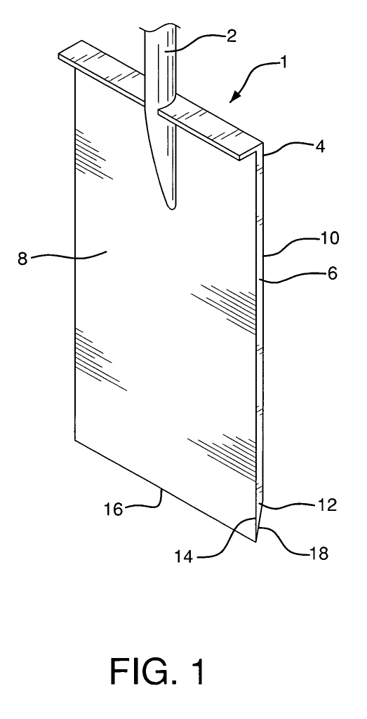

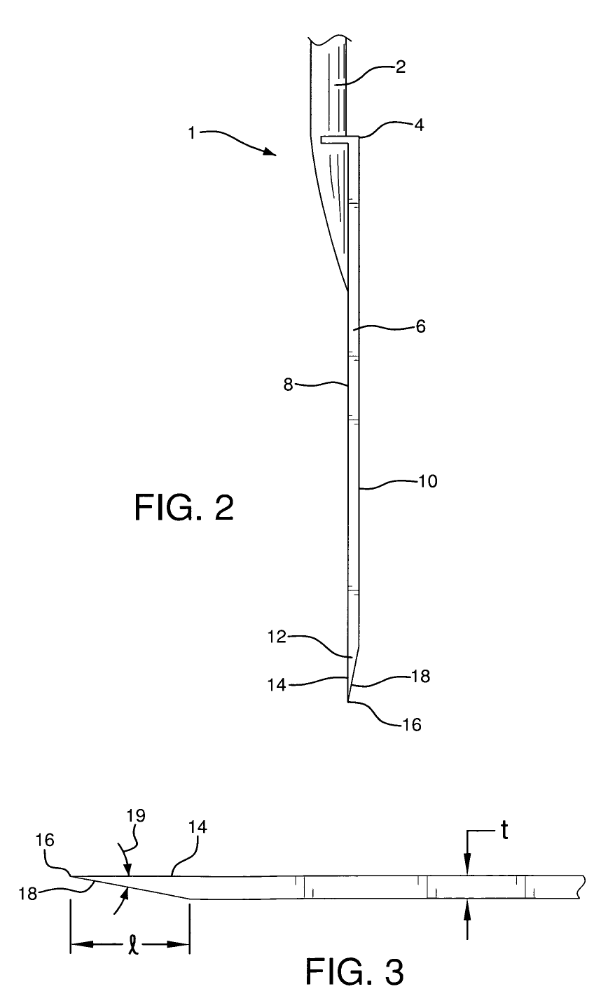

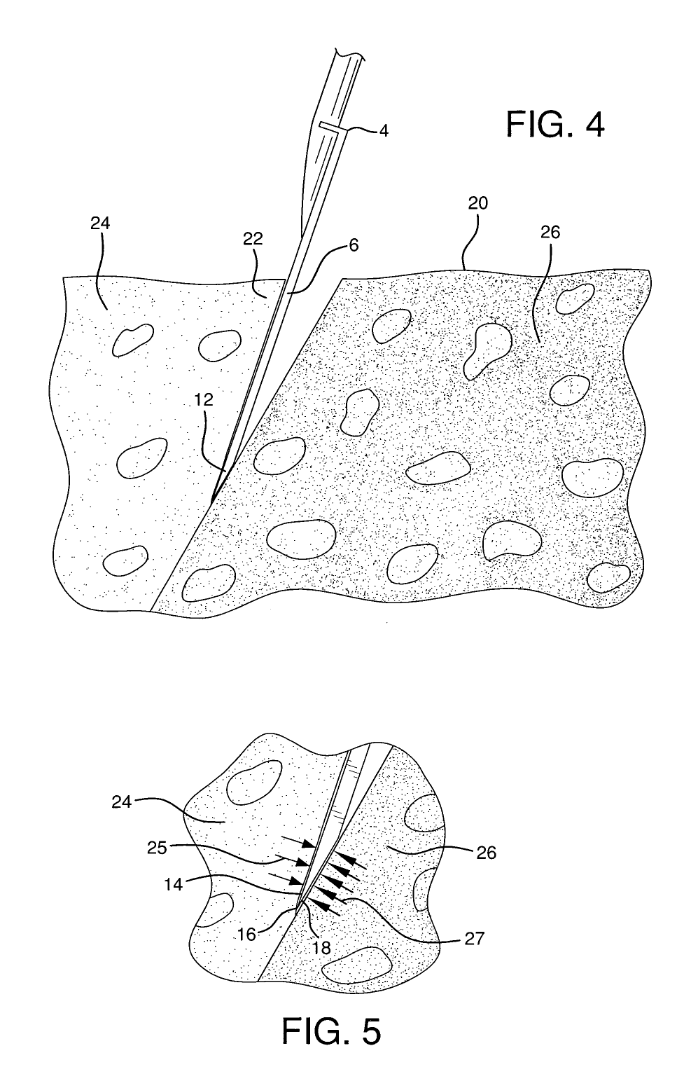

### DETAILED DESCRIPTION OF THE INVENTION

Tool 1 comprises handle 2 and blade 4, configured to penetrate into the surface of the ground and dig within the ground. Blade 4 comprises rear section 6 having top side 8 and back side 10, and tapered front edge section 12 having top surface 14 contiguous with top side 8 of rear section 6. Top surface 14 is shown as being in the same transverse plane as top side 8. It is within the scope of the invention and is contemplated that top surface 14 could be configured at an angle to top side 8.

Front edge section 12 also comprises forwardmost edge tip 16 and bottom surface 18 tapered at an acute taper angle 19 from tip 16 and extending to back side 10 of rear section 6 of blade 4. Tip 16 is a sharp edge surface configured for penetration of the ground, cutting into roots, etc.

In use, front edge section 12 of blade 4 is compelled into and penetrates surface 20 of ground 22 to remove material, in most cases soil. As this is done, blade 4 itself is driven and then inserted into ground 22 to begin the digging operation. As digging commences, the soil 24 contacting top side 8 of rear section 6 and top surface 14 of front edge section 12, becomes loosened, less compacted and relatively moveable, as compared to the hard, undisturbed, still compacted soil 26 which contacts back side 10 and bottom surface 18. The natural effect of this process causes top side 8 and top surface 14 of blade 4 generally to be in contact with loose soil, rock, pebbles, and other debris, i.e. abrasive elements which exert less abrasive forces and less pressure 25 on these surfaces by the loose soil 24, than the abrasive forces and greater pressure 27 resulting from contact with the hard, unmovable soil 26 on back side 10 and bottom surface 18. In other words, as a hole is dug into the ground, top side 8 and top surface 14 of blade 4 contacts loose dirt and debris which is easily moved away from the blade, whereas the dirt and debris contacting back side 10 and bottom surface 18 is, for the most part, immovable, resulting in a higher degree of pressure and abrasive friction, creating a type of sandpaper effect on the bottom of the blade.

Thus, bottom surfaces of blade 4 endure significantly more abrasive effect and pressure 27 than the abrasive effect and pressure 25 experienced on the top surfaces during digging. This differential in wear between the top and bottom of blade 4, and, most importantly between top surface 14 and bottom surface 18 of front edge section 12, serves to constantly maintain taper angle 19 and, in fact, slightly increases the acuteness of the angle over the life of the blade.

It has been found that the best results to preserve and increase the taper angle and hence sharpness of blade 4, occurs when the ratio between the length l of the tapered front edge section 12, and the thickness t of rear section 6 is between 3.5 to 1 and 7 to 1, with the optimum ratio being 5 to 1. Too little taper angle will not achieve the self-sharpening effect and, in fact, will cause increased wear and dulling. Too great an angle will unduly thin out cutting tip 16, thereby weakening and making it susceptible to faster wear and damage, e.g. fatigue, cracking, dings, etc.

While concentration has been directed to a self-sharpening blade for hand type tools, this technology can readily be employed on blades whose surfaces experience differential pressures and abrasive forces. For instance, the cutting edges of lawn mower blades are routinely placed on their top surfaces. By providing these cutting edges on the back sides of the blades rather than the top sides, the cutting edges blades will be maintained. The grass cuttings, dirt, and debris underneath the blade will, in fact, serve to sharpen these edges over time.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A self-sharpening tool blade for penetrating into and digging in the ground comprising:
a unitary blade body comprising:
a rear section of given thickness having a top side and a back side; and
a tapered front edge section having a tapered front edge section with a forwardmost tip, a top surface substantially contiguous with the top surface of the rear section, and a bottom surface tapered at an angle from the tip of the front edge section to the back side of the rear section, whereby during penetration into and digging in the ground, a pressure differential and difference in abrasive effect is created between the top surface and the bottom surface of the front edge section, such that the pressure and abrasive effect are greater on the bottom surface than the top surface, causing the sharpening of the tapered angle of the front edge section.

2. The self-sharpening tool blade as in claim 1 wherein the front edge section is of given length and the rear section is of given thickness such that the ratio of the length of the front edge section to the thickness of the rear section is between 3.5 to 1 and 7 to 1.

3. The self-sharpening tool blade as in claim 1 wherein the front edge section is of given length and the rear section has a given thickness and the ratio between the front edge section and the thickness of the rear section is 5 to 1.

4. The self-sharpening tool blade as in claim 1 wherein the tapered angle is an acute angle and the sharpening increases the acuteness of the angle.

5. A self-sharpening tool for penetrating into and digging in the ground comprising:
blade means for penetration into and digging in the ground, said blade means comprising a rear section having a top side and a back side, and a tapered front edge section with a forwardmost tip, a top surface substantially contiguous with the top side of the rear section, and a bottom surface tapered at an angle from the tip of the front edge section to the back side of the rear section, whereby during penetration into and digging in the ground by the blade means, a pressure differential and difference in abrasive effect is created between the top surface and the bottom surface of the front edge section, such that the pressure and abrasive effect are greater on the bottom surface than the top surface, causing the sharpening of the tapered angle of the front edge section.

6. The self-sharpening tool as in claim 5 wherein the front edge section is of given length and the rear section is of given thickness such that the ratio of the length of the front edge section to the thickness of the rear section is between 3.5 to 1 and 7 to 1.

7. The self-sharpening tool as in claim 5 wherein the front edge section is of given length and the rear section has a given thickness such that the ratio of the length of the front edge section to the thickness of the rear section is 5 to 1.

8. The self-sharpening tool as in claim 1 wherein the tapered angle is an acute angle and the sharpening increases the acuteness of the angle.

9. A method of self-sharpening a tool blade being used to penetrate into and dig in the ground comprising the steps of:
providing a unitary blade having a rear section with a top side and a back side, and a tapered front edge section having a forwardmost tip, a top surface substantially contiguous with the top side of the rear section, and a bottom surface tapered at an angle from the tip of the front edge section to the back side of the rear section;
compelling the tip of the front edge section of the blade into the surface of the ground;
penetrating the surface of the ground with the front edge section of the blade;
inserting the blade into and digging in the ground;
creating a pressure differential and difference in abrasive effect between the top surface and the bottom surface of the tapered front edge section, such that the pressure and abrasive effect are greater on the bottom surface than the top surface; and
thereby causing sharpening of the tapered angle of the tapered front edge section.

10. The method as in claim 9 wherein the tapered angle is an acute angle and the sharpening increases the acuteness of the angle.

11. The method as in claim 9 comprising the additional step of repeatedly inserting the blade into and digging in the ground.
